(19) United States
(12) Patent Application Publication
(10) Pub. No.: US 2005/0242515 A1
(43) Pub. Date: Nov. 3, 2005

(54) Dry gas seal and method for making the same

(76) Inventors: Melvin D. Brooks, Parkville, MD (US); Scott A. Colman, Marriottsville, MD (US); Howard Randall Wihelm, Baltimore, MD (US); William K. Mosley, Bel Air, MD (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/833,831

(22) Filed: Apr. 28, 2004

(51) Int. Cl. F16J 15/34

(52) U.S. Cl. 277/370

(57) ABSTRACT

A dry gas seal for turbo machinery and the like includes a rotating shoulder and mating stationary face seal forming a seal between an associated shaft and outer housing. The shoulder is supported in a segmented holder having a machined shroud in which the shoulder is retained, and a rotor mounted on the shaft and detachably connected with the shroud to facilitate machining the shroud when disassembled from the rotor. The face seal is supported in a segmented housing having a machined first member mounted in the stationary outer housing and retaining an inside portion of the face seal, and a second member retaining an outside portion of the face seal and being detachably connected with the first member to facilitate machining the first member when disassembled from the second member.

### BACKGROUND OF THE INVENTION

The present invention relates to dry gas seals for turbo machinery and the like, and in particular to a segmented construction therefor.

Dry gas seal systems, such as that disclosed in related U.S. patent Publication 2003/0015842, which is hereby incorporated herein by reference, are used in a wide variety of rotary shaft devices, including blowers, compressors, vacuum pumps, expanders and devices in the turbo machinery industry, all of which have critical sealing requirements. Dry gas seal systems provide a barrier between the gas in the working chamber, or process gas, and the external environment to minimize the loss of process gas to the environment. These seals are positioned adjacent to the interface of the rotating shaft with the stationary working chamber or housing. In general, dry gas seals may be of the circumferential type, or the face seal type, and are used in pipeline compressors, refineries, utility plants and other similar applications.

Dry gas face seals generally include a rotating shoulder and a mating stationary face seal to form a seal between an associated shaft and outer housing. The shoulder is typically ring-shaped, and carries a precise sealing face which contacts, and rotates against the face seal to create a secure, durable seal between the shaft and outer housing. The shoulder may be constructed from silicon carbide, or the like, to achieve precise interface with the face seal, and avoid shatter due to rubs that may occur during surge or upset conditions. The shoulder is supported in a shoulder holder, which is mounted on and rotates with the shaft, and retains the shoulder in a precise orientation to ensure proper contact between the opposed seal faces of the shoulder and the face seal.

The face seal is typically a relatively complex assembly, which may be supplied as a preassembled cartridge, and also carries a precise sealing face which contacts the sealing face of the shoulder. The face seal cartridge typically includes biasing means, such as springs or the like, which resiliently urge the two sealing faces together under precisely controlled pressure. The face seal is supported in a stationary seal housing, which is in turn retained in the outer housing of the dry gas seal.

Dry gas seals require very dependable performance, and are installed in the most demanding and critical applications, wherein the time between overhauls is measured in decades, not years. At the heart of every dry gas seal is a lift ramp geometry, which maintains the lifting force in separation between the rotating and stationary seal faces. This ramp geometry causes an increased velocity of the purge gas as it moves through the ramp, sweeping any contamination away from the sealing faces. Other seal designs with constant depth grooves permit contamination to collect and reduce the lifting force between the sealing faces, leading to eventual face contact.

Both the shoulder holder and the face seal housing of typical dry gas seals have a very complex shape, and must be precisely formed to properly retain the shoulder and face seal in the assembly. The most critical support surfaces in both the shoulder holder and the seal housing must be carefully machined and/or ground to exacting tolerances to meet specifications. Due to the complex shape of the shoulder holder and the face seal housing, the machining, grinding, and finishing of the same to meet critical tolerance requirement is very difficult and time-consuming, and therefore adds substantial cost to the manufacturing process. Hence, it would be clearly advantageous to be able to form the shoulder holder and seal housing in a more efficient and cost effective manner, while maintaining and/or improving the precise dimensions that are critical to the proper functioning of the dry gas seal.

### SUMMARY OF THE INVENTION

One aspect of the present invention is a dry gas seal for turbo machinery and the like, which includes a rotating shoulder and mating stationary face seal forming a seal between an associated shaft and outer housing. The shoulder is supported in a segmented holder having a machined shroud in which the shoulder member is retained, and a rotor mounted on the shaft and detachably connected with the shroud to facilitate machining the shroud when disassembled from the rotor. The face seal is supported in a segmented housing having a machined first member operably mounted in the stationary outer housing and retained in an inside portion of the face seal, and a second member retaining an outside portion of the face seal and being detachably connected with the first member to facilitate machining the first member when disassembled from the second member.

Another aspect of the present invention is a dry gas seal for turbo machinery and the like, which includes a rotating shoulder and mating stationary face seal forming a seal between an associated shaft and outer housing. The shoulder is supported in a segmented holder having a machined shroud in which the shoulder is installed, and a rotor mounted on the shaft and detachably connected with the shroud to facilitate machining the shroud when disassembled from the rotor.

Yet another aspect of the present invention is a dry gas seal for turbo machinery and the like which includes a rotating shoulder and mating stationary face seal forming a seal between an associated shaft and outer housing. The face seal is supported in a segmented housing having a machined first member operably mounted in the stationary outer housing and retaining an inside portion of the face seal, and a second member retaining an outside portion of the face seal and being detachably connected with the first member to facilitate machining the first member when disassembled from the second member.

Yet another aspect of the present invention is a method for making dry gas seals of the type having a shoulder configured to rotate with an associated shaft, and a mating face seal configured for stationary support in an associated outer housing, and abutting the shoulder to form a seal between the shaft and the outer housing. The method includes forming a segmented shoulder holder, comprising forming a shroud member with at least one surface configured to support the shoulder in the shroud member for rotation therewith, forming a rotor member configured for mounting on the shaft for rotation therewith, and machining the one surface of the shroud member while disassembled from the rotor member to a precise predetermined specification for exact positioning of the shoulder. The method also includes detachably connecting the rotor member with the shroud member to rotate the shroud member and the shoulder with the shaft, yet facilitate the machining of the machined surface of the shroud when disassembled from the rotor member, and finally mounting the shoulder in the shoulder member for support on the machined surface.

Yet another aspect of the present invention is a method for making dry gas seals of the type having a shoulder configured to rotate with an associated shaft, and a mating face seal configured for stationary support in an associated outer housing, and abutting the shoulder to form a seal between the shaft and the outer housing. The method includes forming a segmented seal housing, comprising forming a first seal housing member configured to be mounted in the outer housing in a stationary condition, and having at least one surface configured to support an inside marginal portion of the face seal, forming a second seal housing member configured to support an outside marginal surface of the face seal, and machining the one surface of the first seal housing member while disassembled from the second seal housing member to precise predetermined specification for exact positioning of the face seal. The method also includes detachably connecting the second seal housing member with the first seal housing member to retain the segmented seal housing and the face seal in the stationary condition in the outer housing, yet facilitate the machining of the machined surface of the first seal housing member when disassembled from the second seal housing member, and finally mounting the face seal in the segmented seal housing for support on the machined surface.

Yet another aspect of the present invention is to provide a segmented construction for the shoulder holder and/or face seal housing, which greatly reduces the time and effort necessary to form the associated parts, and maintains and/or improves the quality of the finished parts. The dry gas seal eliminates bearing oil contamination, and results in reduced maintenance and downtime. The dry gas seal may be used for a wide variety of different applications, and can be provided in different shapes and sizes. The dry gas seal is efficient in use, economical to manufacture, capable of a long operating life, and particularly well adapted for the proposed use.

These and other advantages of the invention will be further understood and appreciated by those skilled in the art by reference to the following written specification, claims, and appended drawings.

### BRIEF DESCRIPTION OF THE DRAWINGS

FIG. 1 is a perspective view of a prior art dry gas seal, wherein a portion thereof has been broken away to reveal internal construction.

FIG. 2 is an enlarged, axial cross-sectional view of a dry gas seal embodying the present invention, shown mounted between an associated shaft and outer housing.

FIG. 3 is an exploded, axial cross-sectional view of a transition housing portion of the dry gas seal shown in FIG. 2.

FIG. 4 is an exploded, axial cross-sectional view of an inboard face seal portion of the dry gas seal shown in FIG. 2, and an associated segmented housing therefor.

FIG. 5 is an exploded, axial cross-sectional view of an outboard face seal portion of the dry gas seal shown in FIG. 2, and an associated segmented housing therefor.

FIG. 6 is an exploded, axial cross-sectional view of inboard and outboard shoulder portions of the dry gas seal shown in FIG. 2, and an associated segmented housing therefor.

FIG. 7 is a perspective view of a shroud portion of one of the face seal housings, showing machined surfaces thereof.

FIG. 8 is a perspective view of a first housing portion of one of the shoulder holders, showing machined surfaces thereof.

FIG. 9 is an exploded, axial cross-sectional view of an alternate embodiment of the inboard and outboard shoulders, and an associated segmented holder therefor.

### DETAILED DESCRIPTION OF THE PREFERRED EMBODIMENTS

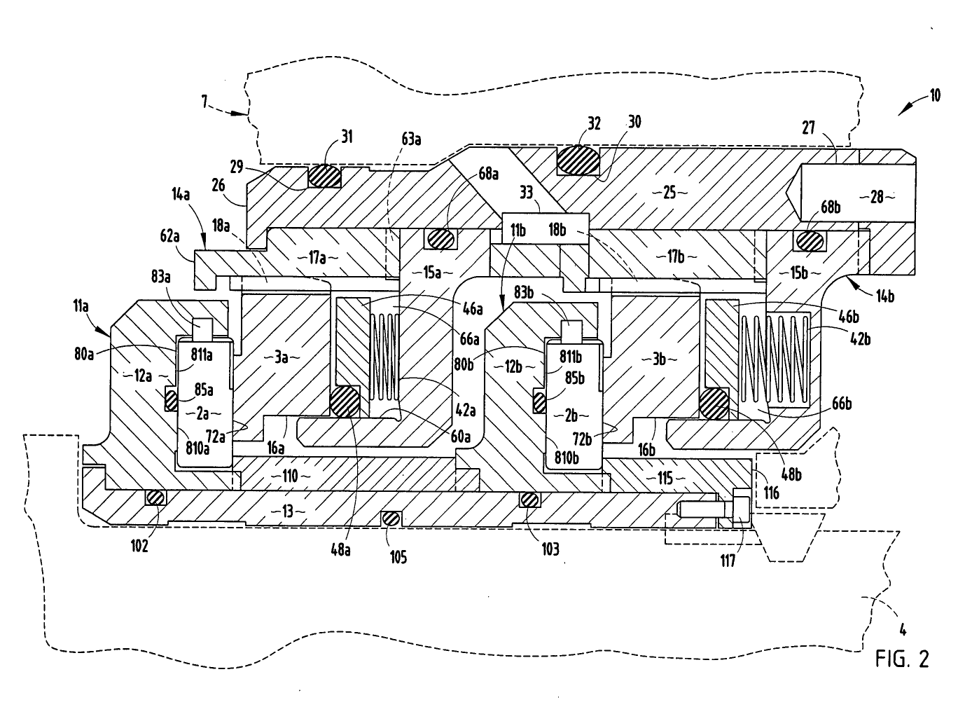

For purposes of description herein the terms “upper”, “lower”, “right”, “left”, “rear”, “front”, “vertical”, “horizontal” and derivatives thereof shall relate to the invention as oriented in FIG. 2. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

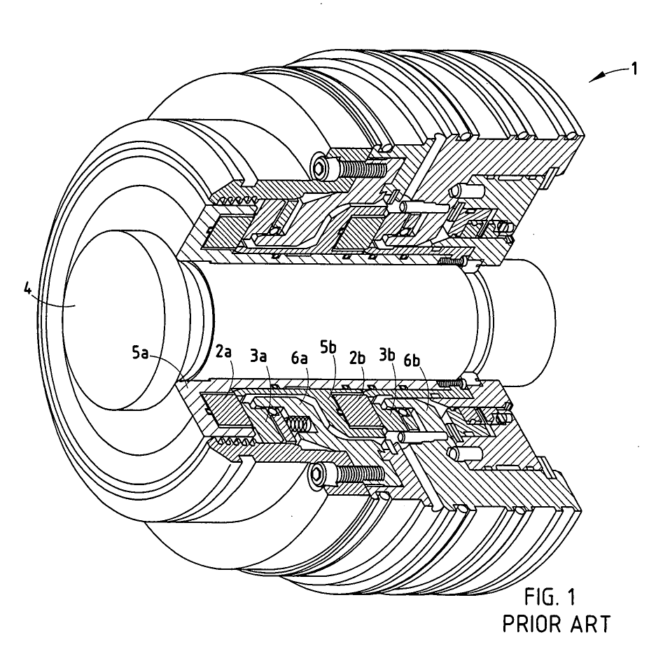

FIG. 1 illustrates a prior art dry gas seal 1 upon which the present invention is an improvement. The illustrated prior art dry gas seal 1 is manufactured by Assignee of the present application, Kaydon Corporation, under the trade name K-DGS2, and is designed for use in conjunction with a wide variety of turbo machinery and the like. Prior dry gas seal 1 includes two rotating shoulders 2a and 2b and two mating stationary face seals 3a and 3b, which collectively form a seal between shaft 4 and an associated outer housing (not shown). Rotating shoulders 2a and 2b are preferably made from a silicon carbide material, so as to provide precise durable sealing surfaces for engaging face seals 3a and 3b, and are retained in rigid holders 5a and 5b, which have a very complex shape, and must be carefully machined and ground to retain shoulders 2a and 2b in their correct orientation relative to face seals 3a and 3b. Face seals 3a and 3b are both cartridge assemblies which include a seal face portion that also may be made from a carbon material to mate with the associated shoulder 2a, 2b. Face seals 3a and 3b are retained in rigid housings 6a and 6b, which also have a very complex shape that must be carefully machined and ground to retain face seals 3a and 3b in their predetermined orientation relative to shoulders 2a and 2b. The complex shapes and critical tolerance requirements of the shoulder holders 5a and 5b and face seal housings 6a and 6b greatly increase the cost and difficulty associated with manufacturing prior dry gas seal 1, which problems are overcome by the present invention, as described below.

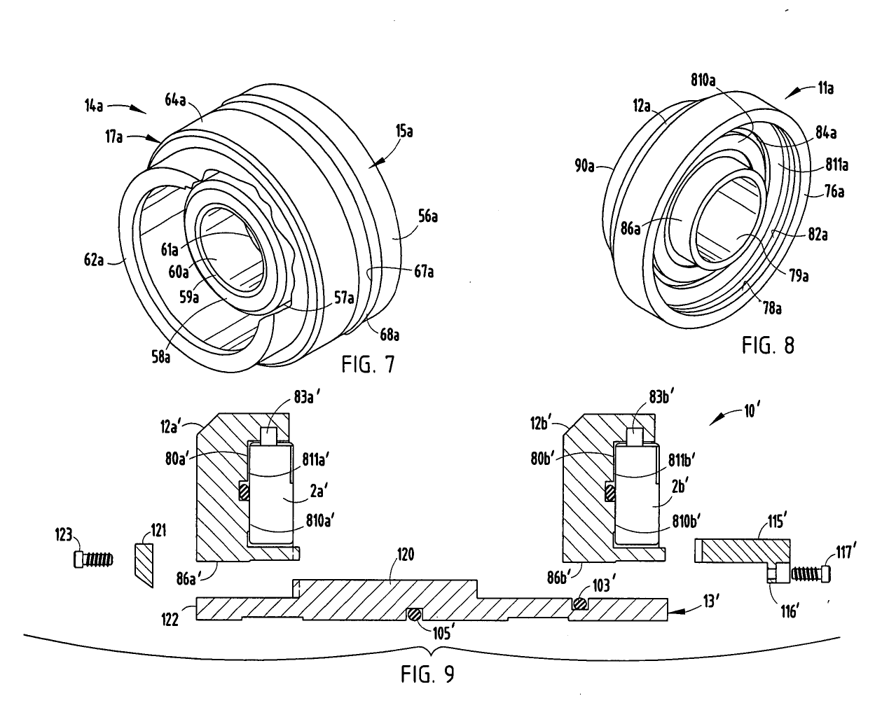

The reference numeral 10 (FIG. 2) illustrates an improved dry gas seal embodying the present invention. Dry gas seal 10 includes two rotating shoulders 2a and 2b and mating stationary face seals 3a and 3b, which are similar in function to those shown in FIG. 1 and described above. However, in contrast to prior art dry gas seal 1, in dry gas seal 10, at least one of the holders for shoulders 2a, 2b, and/or at least one of the housings for face seals 3a, 3b has a segmented construction. In the embodiments shown in FIGS. 2-8, at least one of the shoulders 2a, 2b is supported in a segmented holder 11a, 11b, which comprises a shroud member 12a, 12b having at least one machined surface supporting shoulder 2a, 2b in shroud member 12a, 12b for rotation therewith, and a rotor member 13 configured for mounting on shaft 4 for rotation therewith, and being detachably connected with shroud member 12a, 12b to rotate shroud member 12a, 12b and shoulder 2a, 2b with shaft 4, yet facilitate machining the machined surfaces of shroud member 12a, 12b when disassembled from rotor member 13. Furthermore, in the embodiments shown in FIGS. 2-8, at least one of the face seals 3a, 3b is retained in a segmented seal housing 14a, 14b, comprising a first seal housing member 15a, 15b configured for mounting in the associated outer housing 7 in a stationary condition, and having at least one machined surface supporting an inside marginal portion 16a, 16b of face seal 3a, 3b, and a second seal housing member 17a, 17b supporting an outside marginal portion 18a, 18b of face seal 3a, 3b, and being detachably connected with first seal housing member 15a, 15b to retain the segmented seal housing 14a, 14b and face seal 3a, 3b in the stationary condition in outer housing 7, yet facilitate machining the machined surfaces of the first seal housing member 15a, 15b when disassembled from second seal housing member 17a, 17b.

The illustrated dry gas seal 10 (FIGS. 2-9) is a tandem dry gas seal, which includes two pairs of substantially identical shoulders 2a, 2b and face seals 3a, 3b, as well as segmented shoulder holders 11a, 11b and segmented face seal housings 14a, 14b, which are arranged in an axially spaced apart relationship along shaft 4. In the orientation illustrated in FIG. 2, the shoulder 2a, face seal 3a, segmented shoulder holder 11a and segmented seal housing 14a are disposed adjacent to the left-hand side of FIG. 2, at the process side of the seal, and define an inboard seal assembly, whereas the shoulder 2b, face seal 3b, segmented shoulder holder 11b and segmented seal housing 14b are disposed adjacent the right-hand side of FIG. 2 at the outer or ambient side of the seal, and define an outboard seal assembly. Since the shoulders 2a, 2b, face seals 3a, 3b, segmented shoulder holders 11a, 11b and segmented seal housings 14a, 14b are substantially identical on both the inboard and outboard seal assemblies, the same identical reference numeral is applied to the respective parts, except for the suffixes “a” and “b”. In the illustrated example, segmented shoulder holders 11a, 11b have a common rotor member 13. However, it is to be understood that two separate rotor members could be used for segmented shoulder holders 11a, 11b.

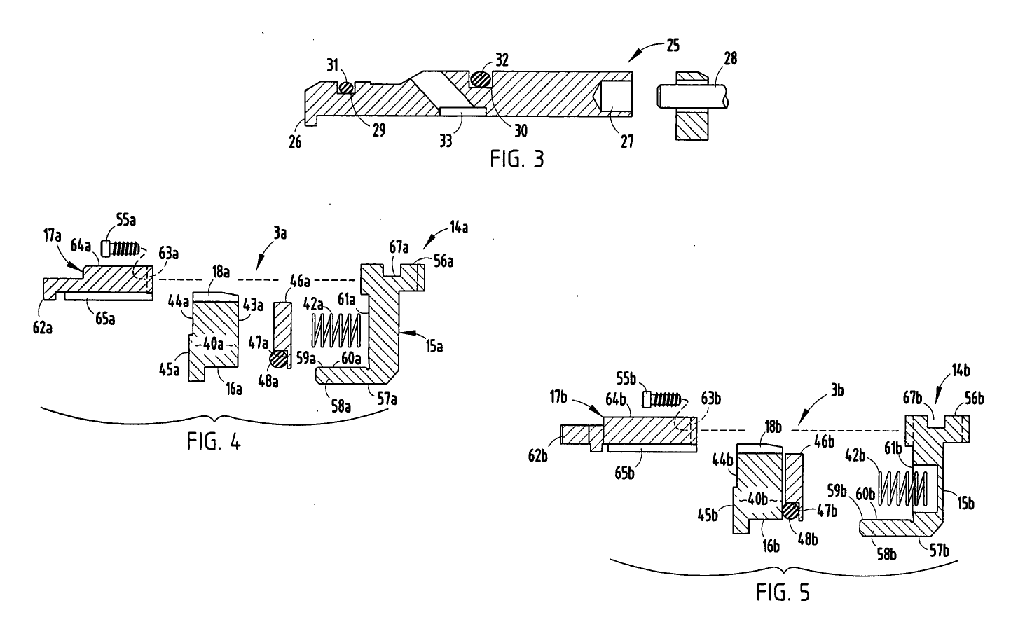

With reference to FIGS. 2 and 3, dry gas seal 10 includes a transition housing 25, which has a generally cylindrical shape, and is disposed between segmented seal housings 14a, 14b and outer housing 7, and serves to operably mount segmented seal housings 14a, 14b in outer housing 7. In the illustrated example, transition housing 25 includes a radially inwardly extending lip 26 at the inboard end thereof, and a pin hole 27 at the outboard end thereof into which a pin 28 is received to retain transition housing 25 in a stationary condition within outer housing 7. Transition housing 25 includes a pair of radially outwardly opening grooves 29 and 30 in which O-rings 31 and 32 are received to seal against the interior surface of outer housing 7. Transition housing 25 also includes a keyway 33 disposed on the interior side thereof, which serves to retain both the inboard and outboard segmented seal housings 14a, 14b in a stationary condition as well, as described in greater detail hereinafter.

FIG. 4 illustrates the inboard face seal 3a and segmented inboard face seal holder 14a.

Inboard face seal 3a comprises a preassembled cartridge 40a, which has a substantially conventional construction, and includes radially inward portion or surface 16a, keyway outer portion or surface 18a, an outboard side surface 43a and an inboard side surface 44a having a radially extending flat sealing face 45a. Face seal 3a also includes a spring 42a and a biasing ring 46a having an open notch 47a at the radially inward inboard portion thereof to receive an O-ring 48a therein. Biasing ring 46a engages the outboard side 43a of face seal cartridge 40a, and resiliently urges sealing face 45a axially in an inboard direction toward shoulder 2a, as described in greater detail below.

In the example illustrated in FIG. 4, the segmented inboard face seal housing 14a comprises first seal housing member 15a and second face seal housing member 17a, which are detachably interconnected by means such as the illustrated threaded fastener 55a. First seal housing member 15a has a generally annular shape with an outer marginal surface 56a configured for close reception within transition housing 25, as shown in FIG. 2, and an inner marginal surface 57a defined by an inwardly protruding flange 58a with a radially outer portion 59a facing transition housing 25, and having a machined surface 60a, which supports inboard face seal 3a thereon. First seal housing member 15a also includes a radially extending rear surface 61a, which is disposed generally perpendicular with surface 60a, and supports the rear face of biasing ring 46a. A U-shaped groove 67a is disposed in the radially outer portion of first seal housing member 15a in which an O-ring 68a is received to seal against transition housing 25. The second seal housing member 17a has a generally cylindrical shape with an outer marginal surface 64a configured for close reception within transition housing 25, and an inner marginal surface 65a supporting the outside marginal portion 18a of face seal cartridge 40a. In the illustrated example, inner marginal surface 65a of housing member 17a defines a key in which the keyway top 18a of face seal cartridge 40a is received to permit face seal cartridge 40a to shift axially. The inner end of second seal housing member 17a has a radially inwardly extending lip portion 62a, and the outer end has a keyway 63a. Fastener 55a, which extends in an axial direction, interconnects first and second face seal housing members 15a and 17a in a coaxial relationship, so as to define a generally U-shaped annular groove 66a in which face seal 3a is closely received and retained in a manner which permits face seal cartridge 40a to shift axially. In the illustrated example, surface 60a is a critical secondary sealing area, and must mate precisely with the associated surface 16a of face seal cartridge 40a, such that the same must be machined and/or ground to very exacting specifications and close tolerances.

FIG. 5 illustrates the outboard face seal 3b and segmented outboard face seal holder 14b. Outboard face seal 3b comprises a preassembled cartridge 40b, which has a substantially conventional construction, and includes a radially inward portion or surface 16b, a keyway outer portion or surface 18b, an outboard side surface 43b and an inboard side surface 44b having a radially extending flat sealing face 45b. Face seal 3b also includes a biasing ring 46b having an open notch 47b at the radially inward inboard portion thereof to receive an O-ring 48b therein. Biasing ring 46b engages the outboard side 43b of face seal cartridge 40b, and resiliently urges sealing face 45b axially in an inboard direction toward shoulder 2b, as described in greater detail below.

In the example illustrated in FIG. 5, the segmented inboard face seal housing 14b comprises first seal housing member 15b and second face seal housing member 17b, which are detachably interconnected by means such as the illustrated threaded fastener 55b. First seal housing member 15b has a generally annular shape with an outer marginal surface 56b configured for close reception within transition housing 25, as shown in FIG. 2, and an inner marginal surface 57b defined by an inwardly protruding flange 58b with a radially outer portion 59b facing transition housing 25, and having a machined surface 60b, which supports inboard face seal 3b thereon. First seal housing member 15b also includes a radially extending rear surface 61b, which is disposed generally perpendicular with surface 60b, and supports the rear face of biasing ring 46b. A U-shaped groove 67b is disposed in the radially outer portion of first seal housing member 15b in which an O-ring 68b is received to seal against transition housing 25. The second seal housing member 17b has a generally cylindrical shape with an outer marginal surface 64b configured for close reception within transition housing 25, as shown in FIG. 2, and an inner marginal surface 65b supporting the outside marginal portion 18b of face seal cartridge 40b. In the illustrated example, inner marginal surface 65b of housing member 17b defines a key in which the keyway top 18b of face seal cartridge 40b is received to permit face seal cartridge 40b to shift axially. The inner end of second seal housing member 17b has an axially extending lip portion 62b, and the outer end has a keyway 63b. Fastener 55b, which extends in an axial direction, interconnects first and second face seal housing members 15b and 17b in a coaxial relationship, so as to define a generally U-shaped annular groove 66b in which face seal 3b is closely received and retained in a manner which permits face seal cartridge 40b to shift axially. In the illustrated example, surface 60b is a critical secondary sealing area, and must mate precisely with the associated surface 16b of face seal cartridge 40b, such that the same must be machined and/or ground to very exacting specifications and close tolerances.

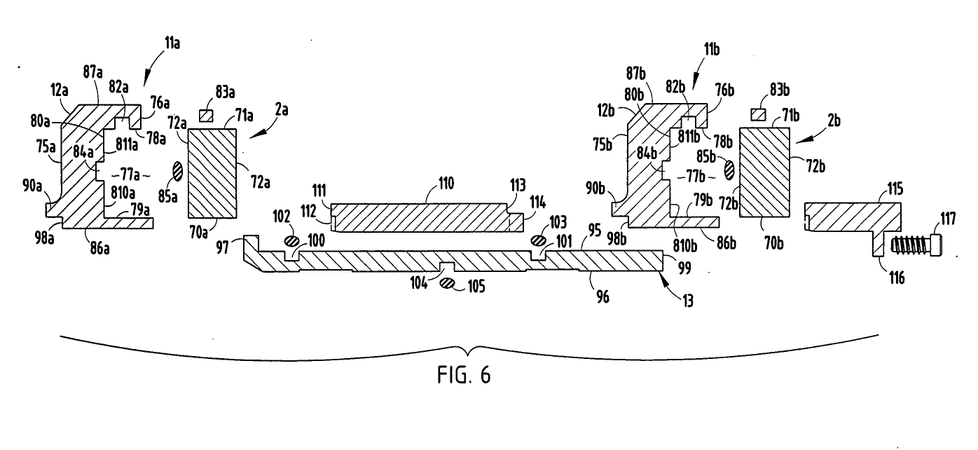

With reference to FIGS. 2 and 6, each of the shoulders 2a, 2b has a substantially conventional construction, comprising an annularly-shaped ring constructed from silicon carbide or the like, and defined by inner edges 70a, 70b, outer edges 71a, 71b and opposite side faces 72a, 72b. In the illustrated example, shoulders 2a, 2b have a generally rectangular radial cross-sectional configuration, wherein the side faces 72a, 72b are substantially longer than the width of inner and outer edges 70a, 70b and 71a, 71b.

The inboard segmented shoulder holder 11a (FIG. 6.) includes shroud member 12a, which is detachably connected with rotor member 13. In the illustrated example, shroud member 12a has a generally annular shape with opposed inner and outer radially extending faces 75a and 76a, and an annularly-shaped groove 77a in outer face 76a to closely receive and retain shoulder 2a therein. Groove 77a has a generally C-shaped radial cross-sectional configuration defined by an outer marginal surface 78a, an inner marginal surface 79a and a rear wall 80a having an annularly-shaped, radially inner portion 810a, an annularly-shaped, radially outer portion 81 la, and an outwardly opening groove 84a between portions 810a and 811a in which an O-ring 85a is received. Since at least one of the surfaces 810a and 811a abuttingly supports the inboard side face 72a of shoulder 2a thereon, the same must be accurately formed and machined. In the illustrated example, the outer marginal surface 78a of shroud member 12a also includes a U-shaped groove 82a in which an associated anti-rotation key 83a is closely received. Shroud member 12a also includes a cylindrical inside surface 86a adapted to mate with the cylindrical outside surface of rotor member 13. The inboard side 75a of shroud member 12a includes an outwardly extending ring 90a, which also mates with rotor member 13, as described in greater detail below. In the illustrated example, surface 810a abuttingly supports the inboard side face 72a of shoulder 2a, and therefore must be machined. and/or ground to very exacting specifications and close tolerances. Surface 811a is preferably relieved or recessed slightly inwardly toward inner face 75a to ensure flush, positive contact between surface 810a and the inboard side face 72a of shoulder 2a. Surfaces 810a and 811a are both difficult to access in the prior art dry gas seal 1 shown in FIG. 1 due to the one-piece construction of holder 5a. The multi-piece construction of segmented shoulder holder 11a greatly facilitates machine access to surfaces 810a and 811a, and accommodates accurate machining of the same in a more effective and efficient manner. [0034] The outboard segmented shoulder holder 11b (FIG. 6) includes shroud member 12b, which is detachably connected with rotor member 13. In the illustrated example, shroud member 12b has a generally annular shape with opposed inner and outer radially extending faces 75b and 76b, and an annularly-shaped groove 77b in outer face 76b to closely receive and retain shoulder 2b therein. Groove 77b has a generally C-shaped radial cross-sectional configuration defined by an outer marginal surface 78b, an inner marginal surface 79b, and a rear wall 80b having an annularly-shaped, radially inner portion 810b, an annularly-shaped, radially outer portion 811b, and an outwardly opening groove 84b between portions 810b and 811b in which an O-ring 85b is received. Since at least one of the surfaces 810b and 811b abuttingly supports the inboard side face 72b of shoulder 2b thereon, the same must be accurately formed and machined. In the illustrated example, the outer marginal surface 78b of shroud member 12b includes a keyway 82b in which an associated anti-rotation key 83b is closely received. Shroud member 12b also includes a cylindrical inside surface 86b adapted to mate with the cylindrical outside surface of rotor member 13. The inboard side 75b of shroud member 12b includes an outwardly extending ring 90b, which mates with a spacer 110, as described in greater detail below. In the illustrated example, surface 810b abuttingly supports the inboard side face 72b of shoulder 2b, and therefore must be machined and/or ground to very exacting specifications and close tolerances. Surface 811b is preferably relieved or recessed slightly inwardly toward inner face 75b to ensure flush, positive contact between surface 810b and the inboard side face 72b of shoulder 2b. As noted above, surfaces 810b and 811b are both difficult to access in the prior art dry gas seal 1 shown in FIG. 1 due to the one-piece construction of holder 5b. The multi-piece construction of segmented shoulder holder 11b greatly facilitates machine access to surfaces 810b and 811b, and accommodates accurate machining of the same in a more effective and efficient manner.

The illustrated rotor member 13 has a generally cylindrical shape with an exterior surface 95 abutting the inner marginal surfaces 86a, 86b of shroud members 12a and 12b to support the same on rotor member 13 in an axially spaced apart relationship. The interior surface 96 of rotor member 13 is shaped to be closely received over shaft 4. The rotor member 13 shown in FIGS. 2 and 6 includes an outwardly extending O-ring 97 at the inboard end, which is received in the groove 98a formed under ring 90a of shroud member 12a, and a flat radially extending outboard end 99. Rotor member 13 also includes two radially outwardly opening grooves 100 and 101 in exterior surface 95, in which O-rings 102 and 103 are received, and an inwardly opening groove 104 in interior surface 96, disposed axially between grooves 100 and 101, in which an O-ring 105 is closely received.

With reference to FIGS. 2 and 6, the illustrated dry gas seal 10 includes a cylindrically-shaped spacer 110 which is received over rotor 13, and is positioned axially between inboard shroud member 12a and outboard shroud member 12b. The inner end 111 of spacer 110 includes a groove 112 which mates with the outboard edge of inboard shroud member 12a. The outer end 113 of spacer 110 includes a rim 114 which mates with the groove 98b on the inner end of outboard shroud member 12b. A cylindrically-shaped locking ring 115 is positioned over the exterior surface 95 of rotor member 13 adjacent the outer end 99 thereof, and includes a radially inwardly extending ring-shaped flange 116 which axially abuts the outer end 99 of rotor 13. Threaded fasteners 117 extend axially through flange 116 and are received into threaded apertures within the outer end 99 of rotor 13 to securely interconnect the inboard and outboard shoulders 2a and 2b, as well as the associated shroud member 12a and 12b, and spacer 110 captured therebetween.

Dry gas seal 10 is preferably manufactured by forming shroud members 12a, 12b and first and second seal housing members 15a, 15b and 17a, 17b as separate components to facilitate machining and/or grinding the various support surfaces, such as surfaces 60a, 60b, 61a, 61b, 78a, 78b, 79a, 79b, 810a, 810b, 811a and 811b. The segmented construction of shoulder holders 11a, 11b and face seal housings 14a, 14b permits the individual parts to be individually formed to the precise dimensions and tolerances specified, as described above, and then assembled to retain shoulders 2a, 2b and face seals 3a, 3b, using fasteners 55a, 55b and 117.

The reference numeral 10′ generally designates another embodiment of the present invention, having an alternate rotor member design. Since dry gas seal 10′ is similar to the previously described dry gas seal 10, similar parts appearing in FIGS. 2-8 and 9 respectively are represented by the same, corresponding reference numeral, except for the suffix “′” in the numerals of the latter. In dry gas seal 10′, rotor member 13′ has an alternate construction, which incorporates an integrally formed spacer 120, instead of the separate spacer 110 of dry gas seal 1. Furthermore, in dry gas seal 10′, the inner end ring 97 of dry gas seal 10 is formed as a separate ring 121, which is attached to the inner end 122 of rotor member 13′ by axially extending threaded fasteners 123.

In both embodiments of the present invention, the segmented construction for the shoulder holders 5a, 5b, as well as the face seal housing 6a, 6b, greatly reduces the time and effort necessary to form the associated parts, and maintains or improves the quality of the finished parts.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. In a dry gas seal of the type having a shoulder configured to rotate with an associated shaft, and a mating face seal configured for stationary support in an associated outer housing, and abutting said shoulder to form a seal between the shaft and the outer housing, the improvement comprising:
a segmented shoulder holder, comprising:
a shroud member having at least one machined surface supporting said shoulder in said shroud member for rotation therewith;
a rotor member configured for mounting on the shaft for rotation therewith, and being detachably connected with said shroud member to rotate said shroud member and said shoulder with the shaft, yet facilitate machining said machined surface of said shroud member when disassembled from said rotor member;
a segmented seal housing, comprising:
a first seal housing member configured for mounting in the outer housing in a stationary condition, and having at least one machined surface supporting an inside marginal portion of said face seal; and
a second seal housing member supporting an outside marginal portion of said face seal, and being detachably connected with said first seal housing member to retain said segmented seal housing and said face seal in said stationary condition in the outer housing, yet facilitate machining said machined surface of said first seal housing member when disassembled from said second seal housing member.

2. A dry gas seal as set forth in claim 1, wherein:
said shroud member has a generally annular shape with opposed inner and outer radially extending faces, and an annularly-shaped groove in said outer face shaped to closely receive and retain said shoulder therein.

3. A dry gas seal as set forth in claim 2, wherein:
said groove has a generally C-shaped radial cross-sectional configuration defined by an outer marginal surface, an inner marginal surface, and a rear wall having said machined surface supporting said shoulder thereon.

4. A dry gas seal as set forth in claim 3, wherein:
said rotor member has a generally cylindrical shape with an exterior surface abutting said inner marginal surface of said shroud member to support said shroud member on said rotor member.

5. A dry gas seal as set forth in claim 4, including:
at least one threaded fastener detachably connecting said rotor member with said shroud member.

6. A dry gas seal as set forth in claim 5, wherein:
said fastener extends axially relative to the shaft.

7. A dry gas seal as set forth in claim 6, wherein:
said first seal housing member has a generally annular shape with an outer marginal surface configured for close reception in the outer housing, and an inner marginal surface defined by an inwardly protruding flange with a radially outer portion thereof facing the outer housing, and having said machined surface supporting said face seal thereon.

8. A dry gas seal as set forth in claim 7, wherein:
said second seal housing member has a generally cylindrical shape with an outer marginal surface configured for close reception in the outer housing, and an inner marginal surface supporting said face seal thereon.

9. A dry gas seal as set forth in claim 8, including:
at least one threaded fastener detachably connecting said first seal housing member with said second seal housing member.

10. A dry gas seal as set forth in claim 9, wherein:
said fastener detachably connecting said first and second seal housing members extends axially relative to the shaft.

11. A dry gas seal as set forth in claim 10, wherein:
said face seal is closely yet slidably retained between said machined surface of said first seal housing member and said inner marginal surface of said second seal housing member to permit said face seal to shift axially relative to said shoulder.

12. A dry gas seal as set forth in claim 11, wherein:
said face seal includes a radially extending sealing face which is biased into engagement with said shoulder.

13. A dry gas seal as set forth in claim 12, including:
an inboard side disposed adjacent to process pressure;
an outboard side disposed adjacent to ambient pressure; and wherein said shoulder defines an inboard shoulder disposed adjacent said inboard side of said dry gas seal;
said shoulder holder defines an inboard shoulder holder disposed adjacent said inboard side of said dry gas seal;
said face seal defines an inboard face seal disposed adjacent said inboard side of said dry gas seal; and
said seal housing defines an inboard seal housing disposed adjacent said inboard side of said dry gas seal.

14. A dry gas seal as set forth in claim 13, including:
an outboard shoulder disposed adjacent said outboard side of said dry gas seal; and
a segmented outboard shoulder holder, comprising:
an outboard shroud member having at least one machined surface supporting said outboard shoulder in said outboard shroud for rotation therewith, and being detachably connected with said rotor member to rotate said outboard shroud member and said outboard shoulder with the shaft, yet facilitate machining said machined surface of said outboard shroud member when disassembled from said rotor member.

15. A dry gas seal as set forth in claims 14, including:
an outboard face seal disposed adjacent said outboard side of said dry gas seal;
a segmented outboard seal housing, comprising:
a first outboard seal housing member configured for mounting in the outer housing in a stationary condition, and having at least one machined surface supporting an inside marginal portion of said outboard face seal; and
a second outboard seal housing member supporting an outside marginal surface of said outboard face seal, and being detachably connected with said first outboard seal housing member to retain said segmented outboard seal housing and said outboard face seal in said stationary condition in the outer housing, yet facilitate machining said machined surface of said first outboard seal housing member when disassembled from said second outboard seal housing member.

16. A dry gas seal as set forth in claim 15, wherein:
said outboard shroud member has a generally annular shape with opposed inner and outer radially extending faces, and an annularly-shaped groove in said outer face shaped to closely receive and retain said outboard shoulder therein.

17. A dry gas seal as set forth in claim 16, wherein:
said groove in said outboard shroud member has a generally C-shaped radial cross-sectional configuration defined by an outer marginal surface, an inner marginal surface, and a rear wall having said machined surface supporting said outboard shoulder thereon.

18. A dry gas seal as set forth in claim 17, wherein:
said exterior surface of said rotor member abuts said inner marginal surface of said outboard shroud member to support said outboard shroud member on said rotor member.

19. A dry gas seal as set forth in claim 18, wherein:
said first outboard seal housing member has a generally annular shape with an outer marginal surface configured for close reception in the outer housing, and an inner marginal surface defined by an inwardly protruding flange with a radially outer portion thereof facing the outer housing, and having said machined surface supporting said outboard face seal thereon.

20. A dry gas seal as set forth in claim 19, wherein:
said second outboard seal housing member has a generally cylindrical shape with an outer marginal surface configured for close reception in the outer housing, and an inner marginal surface supporting said outboard face seal thereon.

21. A dry gas seal as set forth in claim 20, wherein:
said outboard face seal is closely yet slidably retained between said machined surface of said first outboard seal housing member and said inner marginal surface of said second outboard seal housing member to permit said outboard face seal to shift axially relative to said outboard shoulder.

22. A dry gas seal as set forth in claim 21, wherein:
said outboard face seal includes a radially extending sealing face which is biased into engagement with said outboard shoulder.

23. A dry gas seal as set forth in claim 22, including:
a spacer mounted on said rotor member and extending between said inboard shroud member and said outboard shroud member to positively retain the same in a predetermined spaced apart relationship.

24. A dry gas seal as set forth in claim 23, including:
a locking ring mounted on said rotor member and abutting said outer face of said outboard seal housing member to positively retain the same in a predetermined spaced apart relationship with said outboard seal housing.

25. A dry gas seal as set forth in claim 24, including:
at least one threaded fastener detachably connecting said locking ring with said rotor member.

26. A dry gas seal as set forth in claim 25, wherein:
said fastener connecting said locking ring with said rotor member extends axially relative to the shaft.

27. A dry gas seal as set forth in claim 26, wherein:
said locking ring defines an outboard locking ring; and including
an inboard locking ring configured for mounting on the shaft, being detachably connected with said rotor member to rotate with said rotor member and the shaft, and including a radially outwardly protruding collar portion abutting said inboard shroud member to positively retain the same in a predetermined spaced apart relationship with said inboard seal housing.

28. A dry gas seal as set forth in claim 1, wherein:
said rotor member has a generally cylindrical shape with an exterior surface abutting an inner marginal surface of said shroud member to support said shroud member on said rotor member.

29. A dry gas seal as set forth in claim 1, including:
at least one threaded fastener detachably connecting said rotor member with said shroud member.

30. A dry gas seal as set forth in claim 1, wherein:
said first seal housing member has a generally annular shape with an outer marginal surface configured for close reception in the outer housing, and an inner marginal surface defined by an inwardly protruding flange with a radially outer portion thereof facing the outer housing, and having said machined surface supporting said face seal thereon.

31. A dry gas seal as set forth in claim 1, wherein:
said second seal housing member has a generally cylindrical shape with an outer marginal surface configured for close reception in the outer housing, and an inner marginal surface supporting said face seal thereon.

32. A dry gas seal as set forth in claim 1, including:
at least one threaded fastener detachably connecting said first seal housing member with said second seal housing member.

33. A dry gas seal as set forth in claim 1, wherein:
said face seal is closely yet slidably retained between said machined surface of said first seal housing member and an inner marginal surface of said second seal housing member to permit said face seal to shift axially relative to said shoulder.

34. A dry gas seal as set forth in claim 1, wherein:
said face seal includes a radially extending sealing face which is biased into engagement with said shoulder.

35. A dry gas seal as set forth in claim 1, including:
an inboard side disposed adjacent to process pressure;
an outboard side disposed adjacent to ambient pressure; and wherein
said shoulder defines an inboard shoulder disposed adjacent said inboard side of said dry gas seal;
said shoulder holder defines an inboard shoulder holder disposed adjacent said inboard side of said dry gas seal;
said face seal defines an inboard face seal disposed adjacent said inboard side of said dry gas seal; and
said seal housing defines an inboard seal housing disposed adjacent said inboard side of said dry gas seal.

36. A dry gas seal as set forth in claim 35, including:
an outboard shoulder disposed adjacent said outboard side of said dry gas seal;
an outboard face seal disposed adjacent said outboard side of said dry gas seal;
a segmented outboard shoulder holder, comprising:
an outboard shroud member having at least one machined surface supporting said outboard shoulder in said outboard shroud for rotation therewith, and being detachably connected with said rotor member to rotate said outboard shroud member and said outboard shoulder with the shaft, yet facilitate machining said machined surface of said outboard shroud member when disassembled from said rotor member;
a segmented outboard seal housing, comprising:
a first outboard seal housing member configured for mounting in the outer housing in a stationary condition, and having at least one machined surface supporting an inside marginal portion of said outboard face seal; and
a second outboard seal housing member supporting an outside marginal portion of said outboard face seal, and being detachably connected with said first outboard seal housing member to retain said segmented outboard seal housing and said outboard face seal in said stationary condition in the outer housing, yet facilitate machining said machined surface of said first outboard seal housing member when disassembled from said second outboard seal housing member.

37. A dry gas seal as set forth in claim 35, wherein:
said outboard shroud member has a generally annular shape with opposed inner and outer radially extending faces, and an annularly-shaped groove in said outer face shaped to closely receive and retain said outboard shoulder therein; and
said groove in said outboard shroud member has a generally C-shaped radial cross-sectional configuration defined by an outer marginal surface, an inner marginal surface, and a rear wall having said machined surface supporting said outboard shoulder thereon.

38. A dry gas seal as set forth in claim 35, wherein:
said first outboard seal housing member has a generally annular shape with an outer marginal surface configured for close reception in the outer housing, and an inner marginal surface defined by an inwardly protruding flange with a radially outer portion thereof facing the outer housing, and having said machined surface supporting said outboard face seal thereon.

39. A dry gas seal as set forth in claim 35, including:
a spacer mounted on said rotor member and extending between said inboard shroud member and said outboard shroud member to positively retain the same in a predetermined spaced apart relationship;
a locking ring mounted on said rotor member and abutting said outer face of said outboard seal housing member to positively retain the same in a predetermined spaced apart relationship with said outboard seal housing; and
at least one threaded fastener detachably connecting said locking ring with said rotor member.

40. In a dry gas seal of the type having a shoulder configured to rotate with an associated shaft, and a mating face seal configured for stationary support in an associated outer housing, and abutting said shoulder to form a seal between the shaft and the outer housing, the improvement comprising:
a segmented shoulder holder, comprising:
a shroud member having at least one machined surface supporting said shoulder in said shroud member for rotation therewith; and
a rotor member configured for mounting on the shaft for rotation therewith, and being detachably connected with said shroud member to rotate said shroud member and said shoulder with the shaft, yet facilitate machining said machined surface of said shroud member when disassembled from said rotor member.

41. A dry gas seal as set forth in claim 40, wherein:
said shroud member has a generally annular shape with opposed inner and outer radially extending faces, and an annularly-shaped groove in said outer face shaped to closely receive and retain said shoulder therein.

42. A dry gas seal as set forth in claim 41, wherein:
said groove has a generally C-shaped radial cross-sectional configuration defined by an outer marginal surface, an inner marginal surface, and a rear wall having said machined surface supporting said shoulder thereon.

43. A dry gas seal as set forth in claim 42, wherein:
said rotor member has a generally cylindrical shape with an exterior surface abutting said inner marginal surface of said shroud member to support said shroud member on said rotor member.

44. A dry gas seal as set forth in claim 43, including:
at least one threaded fastener detachably connecting said rotor member with said shroud member.

45. A dry gas seal as set forth in claim 44, wherein:
said fastener extends axially relative to the shaft.

46. In a dry gas seal of the type having a shoulder configured to rotate with an associated shaft, and a mating face seal configured for stationary support in an associated outer housing, and abutting said shoulder to form a seal between the shaft and the outer housing, the improvement comprising:
a segmented seal housing, comprising:
a first seal housing member configured for mounting in the outer housing in a stationary condition, and having at least one machined surface supporting an inside marginal portion of said face seal; and
a second seal housing member supporting an outside marginal surface of said face seal, and being detachably connected with said first seal housing member to retain said segmented seal housing and said face seal in said stationary condition.

47. A dry gas seal s set forth in claim 46, wherein:
said first seal housing member has a generally annular shape with an outer marginal surface configured for close reception in the outer housing, and an inner marginal surface defined by an inwardly protruding flange with a radially outer portion thereof facing the outer housing, and having said machined surface supporting said face seal thereon.

48. A dry gas seal as set forth in claim 47, wherein:
said second seal housing member has a generally cylindrical shape with an outer marginal surface configured for close reception in the outer housing, and an inner marginal surface supporting said face seal thereon.

49. A dry gas seal as set forth in claim 48, including:
at least one threaded fastener detachably connecting said first seal housing member with said second seal housing member.

50. A dry gas seal as set forth in claim 49, wherein:
said face seal is closely yet slidably retained between said machined surface of said first seal housing member and said inner marginal surface of said second seal housing member to permit said face seal to shift axially relative to said shoulder.

51. A dry gas seal as set forth in claim 50, wherein:
said face seal includes a radially extending sealing face which is biased into engagement with said shoulder.

52. In a method for making dry gas seals of the type having a shoulder configured to rotate with an associated shaft, and a mating face seal configured for stationary support in an associated outer housing, and abutting the shoulder to form a seal between the shaft and the outer housing, the improvement, comprising:
forming a segmented shoulder holder, comprising:
forming a shroud member with at least one surface configured to support the shoulder in the shroud member for rotation therewith;
forming a rotor member configured for mounting on the shaft for rotation therewith;
machining the one surface of the shroud member while disassembled from the rotor member to a precise predetermined specification for exact positioning of the shoulder;
detachably connecting the rotor member with the shroud member to rotate the shroud member and the shoulder with the shaft, yet facilitate said machining of the machined surface of the shroud member when disassembled from the rotor member; and
mounting the shoulder in the shroud member for support on the machined surface thereof.

53. A method as set forth in claim 52, including:
forming a segmented seal housing, comprising:
forming a first seal housing member configured for mounting in the outer housing in a stationary condition, and having at least one surface configured to support an inside marginal portion of the face seal;
forming a second seal housing member configured to support an outside marginal surface of the face seal;
machining the one surface of the first seal housing member while disassembled from the second seal housing member to a precise predetermined specification for exact positioning of the face seal;
detachably connecting the second seal housing member with the first seal housing member to retain said segmented seal housing and the face seal in the stationary condition in the outer housing, yet facilitate said machining of the machined surface of said first seal housing member when disassembled from the second seal housing member; and
mounting the face seal in the segmented seal housing for support on the machined surface thereof.

54. A method as set forth in claim 53, wherein:
said shroud member forming step includes forming an annularly-shaped groove in an outer face of the shroud member, and inserting the shoulder in the groove.

55. A method as set forth in claim 54, wherein:
said shroud member machining step includes machining a rear wall of the groove to define the machined surface on which the shoulder is precisely supported.

56. A method as set forth in claim 55, wherein:
said rotor member forming step includes forming the rotor member into a generally cylindrical shape with an exterior surface abutting the inner marginal surface of the shroud member to support the shroud member on the rotor member.

57. A method as set forth in claim 56, wherein:
said first seal housing member forming step includes forming a generally annular shape with an outer marginal surface configured for close reception in the outer housing, and an inner marginal surface defined by an inwardly protruding flange with a radially outer portion thereof facing the outer housing; and
said first seal housing machining step includes machining the outer portion of the flange to precisely support the face seal in the segmented seal housing.

58. A method as set forth in claim 57, including:
positioning the shoulder adjacent an inboard side of the dry gas seal in communication with process pressure;
positioning the shoulder holder adjacent the inboard side of the dry gas seal;
positioning the face seal adjacent the inboard side of said dry gas seal; and
positioning the seal housing adjacent the inboard side of said dry gas seal.

59. A method as set forth in claim 58, including:
forming a segmented outboard shoulder holder, comprising:
forming an outboard shroud member with at least one surface configured to support an outboard shoulder in the outboard shroud member for rotation therewith;
forming an outboard rotor member configured for mounting on the shaft for rotation therewith;
machining the one surface of the outboard shroud member while disassembled from the outboard rotor member to a precise predetermined specification for exact positioning of the outboard shoulder;
detachably connecting the outboard rotor member with the outboard shroud member to rotate the outboard shroud member and the outboard shoulder with the shaft, yet facilitate said machining of the machined surface of the outboard shroud member when disassembled from the outboard rotor member; and
mounting the outboard shoulder in the outboard shroud member for support on the machined surface thereof.

60. A method as set forth in claim 59, including:
forming a segmented outboard seal housing, comprising:
forming a first outboard seal housing member configured for mounting in the outer housing in a stationary condition, and having at least one surface configured to support an inside marginal portion of an outboard face seal;
forming a second outboard seal housing member configured to support an outside marginal surface of the outboard face seal;
machining the one surface of the first outboard seal housing member while disassembled from the second outboard seal housing member to precise predetermined specification for exact positioning of the outboard face seal;
detachably connecting the second outboard seal housing member with the first outboard seal housing member to retain said segmented outboard seal housing and the outboard face seal in the stationary condition in the outer housing, yet facilitate said machining of the machined surface of said first outboard seal housing member when disassembled from the second outboard seal housing member; and
mounting the outboard face seal in the segmented outboard seal housing for support on the machined surface thereof.

61. A method as set forth in claim 60, wherein:
said outboard shroud member forming step includes forming an annularly-shaped groove in an outer face of the outboard shroud member, and inserting the outboard shoulder in the groove.

62. A method as set forth in claim 61, wherein:
said outboard shroud member machining step includes machining a rear wall of the groove to define the machined surface on which the outboard shoulder is precisely supported.

63. A method as set forth in claim 62, wherein:
said outboard rotor member forming step includes forming the outboard rotor member into a generally cylindrical shape with an exterior surface abutting the inner marginal surface of the outboard shroud member to support the outboard shroud member on the outboard rotor member.

64. A method as set forth in claim 63, wherein:
said first outboard seal housing member forming step includes forming a generally annular shape with an outer marginal surface configured for close reception in the outer housing, and an inner marginal surface defined by an inwardly protruding flange with a radially outer portion thereof facing the outer housing; and
said first outboard seal housing machining step includes machining the outer portion of the flange to precisely support the outboard face seal in the segmented outboard seal housing.

65. A method as set forth in claim 52, wherein:
said shroud member forming step includes forming an annularly-shaped groove in an outer face of the shroud member, and inserting the shoulder in the groove.

66. A method as set forth in claim 65, wherein:
said shroud member machining step includes machining a rear wall of the groove to define the machined surface on which the shoulder is precisely supported.

67. A method as set forth in claim 52, wherein:
said rotor member forming step includes forming the rotor member into a generally cylindrical shape with an exterior surface abutting the inner marginal surface of the shroud member to support the shroud member on the rotor member.

68. A method as set forth in claim 52, wherein:
said first seal housing member forming step includes forming a generally annular shape with an outer marginal surface configured for close reception in the outer housing, and an inner marginal surface defined by an inwardly protruding flange with a radially outer portion thereof facing the outer housing; and
said first seal housing machining step includes machining the outer portion of the flange to precisely support the face seal in the segmented seal housing.

69. A method as set forth in claim 52, including:
positioning the shoulder adjacent an inboard side of the dry gas seal in communication with process pressure;
positioning the shoulder holder adjacent the inboard side of the dry gas seal;
positioning the face seal adjacent the inboard side of said dry gas seal; and
positioning the seal housing adjacent the inboard side of said dry gas seal.

70. A method as set forth in claim 69, including:
forming a segmented outboard shoulder holder, comprising:
forming an outboard shroud member with at least one surface configured to support an outboard shoulder in the outboard shroud member for rotation therewith;
forming an outboard rotor member configured for mounting on the shaft for rotation therewith;
machining the one surface of the outboard shroud member while disassembled from the outboard shroud member to a precise predetermined specification for exact positioning of the outboard shoulder;
detachably connecting the outboard rotor member with the outboard shroud member to rotate the outboard shroud member and the outboard shoulder with the shaft, yet facilitate said machining of the machined surface of the outboard shroud member when disassembled from the outboard rotor member; and
mounting the outboard shoulder in the outboard shroud member for support on the machined surface.

71. A method as set forth in claim 70, wherein:
said outboard shroud member forming step includes forming an annularly-shaped groove in an outer face of the outboard shroud member, and inserting the outboard shoulder in the groove; and
said outboard shroud member machining step includes machining a rear wall of the groove to define the machined surface on which the outboard shoulder is precisely supported.

72. A method as set forth in claim 70, wherein:
said outboard rotor member forming step includes forming the outboard rotor member into a generally cylindrical shape with an exterior surface abutting the inner marginal surface of the outboard shroud member to support the outboard shroud member on the outboard rotor member.

73. In a method for making dry gas seals of the type having a shoulder configured to rotate with an associated shaft, and a mating face seal configured for stationary support in an associated outer housing, and abutting the shoulder to form a seal between the shaft and the outer housing, the improvement, comprising:
forming a segmented seal housing, comprising:
forming a first seal housing member configured for mounting in the outer housing in a stationary condition, and having at least one surface configured to support an inside marginal portion of the face seal;
forming a second seal housing member configured to support an outside marginal surface of the face seal;
machining the one surface of the first seal housing member while disassembled from the second seal housing member to a precise predetermined specification for exact positioning of the face seal;
detachably connecting the second seal housing member with the first seal housing member to retain said segmented seal housing and the face seal in the stationary condition in the outer housing, yet facilitate said machining of the machined surface of said first seal housing member when disassembled from the second seal housing member; and
mounting the face seal in the segmented seal housing for support on the machined surface thereof.

74. A method as set forth in claim 73, wherein:
said first seal housing member forming step include forming-a generally annular shape with an outer marginal surface configured for close reception in the outer housing, and an inner marginal surface defined by an inwardly protruding flange with a radially outer portion thereof facing the outer housing; and
said first seal housing machining step includes machining the outer portion of the flange to precisely support the face seal in the segmented seal housing.
